(19) United States
(12) Patent Application Publication
(10) Pub. No.: US 2008/0088825 A1
(43) Pub. Date: Apr. 17, 2008

(54) IR spectroscopy analysis apparatus with coupling device

(75) Inventors: John Richmond, Coventry (GB); Mike Fenner, Solihull (GB)

Correspondence Address: KOHLER SCHMID MOEBUS, RUPPMANNSTRASSE 27, D-70565 STUTTGART, omitted

(73) Assignee: Bruker Optik GmbH, Ettlingen (DE)

(21) Appl. No.: 11/905,636

(22) Filed: Oct. 3, 2007

(30) Foreign Application Priority Data
Oct. 11, 2006 (DE) 10 2006 048 100.3

(51) Int. Cl. G01J 3/00

(52) U.S. Cl. 356/51

(57) ABSTRACT

An apparatus for the analysis of a sample by means of an infrared (IR) spectroscopy, comprising a vessel (1) rotating during operation for holding the sample, a measuring head (2, 2′) connected with the vessel, a spectrometer (8) which is supplied with IR radiation reflected by the sample, and at least one first optical fiber element (4a) for transmitting the IR radiation reflected by the sample, is characterized in that the spectrometer (8) is stationary and a first rotary feed through (7, 7′, 7a, 7a′) is provided for coupling the reflected IR radiation from the first optical fiber element (4a) into a second optical fiber element (4b), in which the first optical fiber element (4a) is connected with the rotating part of the first rotary feed through (7, 7′, 7a, 7a′) and the spectrometer (8) is connected with the stationary part of the first rotary feed through (7, 7′, 7a, 7a′) via the second optical fiber element (4b). The apparatus according to the invention ensures sufficient stability, requires little space and allows for the use of powerful spectrometers.

This application claims Paris Convention priority of DE 10 2006 048 100.3 filed Oct. 11, 2006 the complete disclosure of which is hereby incorporated by reference.

### BACKGROUND OF THE INVENTION

The invention concerns an apparatus for the analysis of a sample by means of infrared (IR) spectroscopy, comprising a vessel rotating during operation for holding the sample, a measuring head connected with the vessel, a spectrometer which is supplied with IR radiation reflected by the sample, and at least one first optical fiber element for transmitting the IR radiation reflected by the sample. The optical fiber element can be designed as a single optical fiber or as a bundle of several optical fibers.

A measuring head for illuminating a sample and for detecting the radiation reflected by the sample, mountable on a mixing vessel, is e.g. known from [1].

For many branches of industry, IR spectroscopy is of particular importance since with this method it is possible to carry out a multitude of measurements with different parameters rapidly and without having to carry out separate preparation of the sample to be measured. Especially in the pharmaceutical industry, IR spectroscopy is used for testing, for example, the homogeneity of substance mixtures. IR spectrums are thereby recorded at various stages of the mixing process. It is assumed that an optimum mixture is achieved when the IR spectra no longer change, despite further mixing. The IR spectra are recorded during the running mixing process so that this process need not be interrupted, since this would result in considerable loss of time.

The substances to be mixed are usually filled in a rotating vessel provided with an IR-permeable window. Reference [2] discloses a mixing system with an IR analysis apparatus in which the mixing vessel is suspended on one side and the rotation is around this suspension. The IR-permeable window through which IR radiation can be irradiated by way of a measuring head is located on the side of the vessel opposite to the suspension, along the rotation axis. The measuring head is mounted stationary in the window area and connected to a spectrometer and evaluation electronics via electrical lines and optical fibers. The disadvantage of this system is that the mixing vessel is suspended on only one side, which might be problematic as to the stability of the system especially when-using large mixing vessels. Therefore, the construction of such systems is very costly, time-consuming and material-intensive. Moreover, a second suspension is often desirable for the installation of stirring devices.

The system known from [1] solves this problem by mounting the measuring head with the spectrometer described there directly to the mixing vessel so that it rotates with it. This means that the position of the measuring head is not limited to the rotation axis of the mixing vessel, and an increased stability of the system can be accomplished via a two-sided suspension. Nevertheless, this apparatus can only be implemented for small, low power spectrometers, since the resulting unbalance of the rotating system would otherwise be too large. Moreover, there might be problems with the electronics due to centrifugal forces and vibrations.

The task of the invention is therefore to suggest an apparatus for the analysis of a rotating sample by means of IR spectroscopy, which ensures sufficient stability, requires little space and allows for the use of powerful spectrometers.

### SUMMARY OF THE INVENTION

This task is solved by the invention in such a way that the spectrometer is stationary and that a first rotary feed through is provided for coupling the reflected IR radiation from the first optical fiber element into a second optical fiber element, the first optical fiber element being connected with the rotating part of the first rotary feed through and the spectrometer being connected with the stationary part of the first rotary feed through via the second optical fiber element.

Therefore, in the apparatus according to the invention, only the measuring head rotates with the mixing vessel while the actual spectrometer is stationary. The transmission of the IR radiation reflected by the sample takes place via two optical fiber elements connected via a rotary feed through. The measuring head comprises optics for receiving and coupling the light emanating from the sample to be measured into the first optical fiber element. Glass fibers or glass fiber bundles are especially suitable for optical fiber elements. In the simplest case, the optics of the measuring head is a suitably formed end of the first optical fiber element. The IR radiation carried in the first optical fiber element is fed into the second, non-rotating optical fiber element via the first rotary feed through and via this, transmitted to the stationary spectrometer.

Since the measuring head connected with the vessel has a relatively small mass and the heavy components (spectrometer with interferometer and evaluation electronics) of the apparatus according to the invention are stationary, the risk of imbalance of the vessel is very low even at high numbers of revolutions (10 to 25 revolutions per minute). The stationary arrangement of the spectrometer allows for the use of heavy-duty spectrometers since it is not necessary to consider the mass of the spectrometer. Moreover, the position of the measuring head of the apparatus according to the invention is not limited to the rotation axis but can be selected almost arbitrarily; it can, for example, be adapted to the filling level of the vessel. Further advantages of the apparatus according to the invention are that the motor power of the motor driving the mixing vessel can be reduced compared to [2] since the heavy parts of the analysis apparatus are not rotated, and that it allows for a two-sided as well as a one-sided suspension of the vessel.

In a preferable embodiment of the apparatus according to the invention, the measuring head comprises at least one IR light source with which the sample is illuminated during the measurement. The IR light source and optics for the detection of the radiation emanating from the sample can thus be placed in a common housing.

It is thereby advantageous to provide sliding contacts at the first rotary feed through via which the IR light source is energized during operation. The sliding contacts form a conductive connection between a stationary electrical lead to a power source and a rotating electrical lead to the IR light source.

An alternative embodiment provides for a stationary IR light source. The supply of the light of the IR light source then takes place via an optical fiber element. In this case, the IR light source is not part of the measuring head and does not rotate with the vessel.

In a further development of this embodiment, the first and second optical fiber elements are each designed as individual optical fibers and the second optical fiber element provides for a beam splitter for coupling in IR light of the stationary IR light source.

An illumination optics for the illumination of the sample is preferably provided, having a third optical fiber element and a fourth optical fiber element, the third optical fiber element being connected with the IR light source and the fourth optical fiber element transmitting the IR radiation of the IR light source to the sample. The IR radiation of the IR light source is thereby coupled from the third optical fiber element into the fourth optical fiber element leading to the sample. The irradiation of the IR radiation on the sample can thus be implemented at a different place than the detection of the IR radiation emanating from the sample.

It is especially advantageous when the third optical fiber element is connected with the stationary part and the fourth optical fiber element with the rotating part of the first rotary feed through, either the first and second optical fiber elements or the third and fourth optical fiber elements in the first rotary feed through being designed as ring-shaped optical fiber bundles. In this embodiment, only one common rotary feed through is required for the four optical fiber elements.

In a further development of this embodiment, the vessel provides two rotatable suspensions, the third optical fiber element is connected with the stationary part and the fourth optical fiber element with the rotating part of a second rotary feed through, the first rotary feed through being arranged at the first suspension and the second rotary feed through at the second suspension. The IR light source and the measuring head are then located at opposing places of the vessel.

It is especially advantageous when the vessel has a window and the measuring head is located at the window, particularly flanged. The measuring head does not then come into direct contact with the substance to the measured. Moreover, there is no feed through for the measuring head required in the vessel.

The window of the vessel is preferably arranged eccentrically with respect to the rotary axis of the vessel.

In a preferable embodiment of the apparatus according to the invention, the spectrometer is a Fourier spectrometer.

Further advantages of the invention arise from the description and drawing. The characteristics stated above and below can also be used separately or in any combination. The embodiments shown and described are not exhaustive but are examples for describing the invention.

### BRIEF DESCRIPTION OF THE DRAWING

FIG. 1 shows a schematic cross-section through an analysis apparatus according to the invention with an IR light source integrated in a measuring head.

FIG. 2 shows a schematic cross-section through an analysis apparatus according to the invention with a two-sided vessel suspension and an IR light source integrated in a measuring head.

FIG. 3a shows a schematic cross-section through an analysis apparatus according to the invention with a stationary IR light source.

FIG. 3b shows a schematic cross-section through two optical fiber elements of an analysis apparatus according to the invention, forming a glass fiber bundle.

FIG. 4 shows a schematic cross-section through an analysis apparatus according to the invention with a two-sided vessel suspension and a stationary IR light source.

FIG. 5 shows a schematic cross-section through an analysis apparatus according to the invention with an eccentric arrangement of the measuring head.

### DESCRIPTION OF THE PREFERRED EMBODIMENT

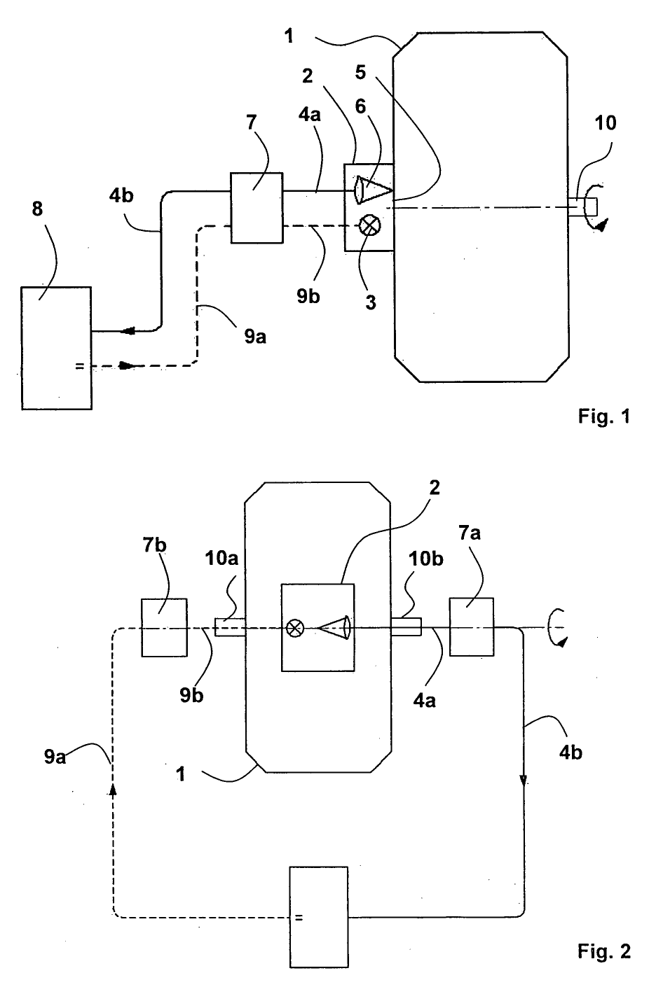

FIG. 1 shows an analysis apparatus according to the invention, especially for mixing and drying processes, with a measuring head 2 located outside a vessel 1. The measuring head 2 comprises an IR light source 3 for illuminating the sample. An optics 6 receives the IR radiation reflected by the sample. In the embodiment shown in FIG. 1, the sample is irradiated with the IR radiation through a window 5 integrated in the vessel 1, “window” meaning an IR-permeable area of the vessel 1. The measuring head 2 can be mounted directly to the window 5, particularly flanged, or to a frame (not shown) in which the vessel is hung and which rotates with the vessel.

The IR radiation emanating from the sample is focused through the optics 6 and coupled in a first optical fiber element 4a. The optics 6 can, for example, be a suitably formed end of the first optical fiber element 4a. It is nevertheless also possible to provide further optical elements such as lenses or mirrors for focusing the IR radiation. In a preferable version of the apparatus according to the invention, the IR light source 3 is formed as an illumination ring in the center of which the optics 6 is located. It can also be advantageous to arrange the first optical fiber element 4a in the form of an hoptical fiber bundle around the IR light source 3.

The first optical fiber element 4a transmits the IR radiation to a first rotary feed through 7. The rotary feed through 7 consists of a rotary part and a stationary part, the rotary part being connected with the first optical fiber element 4a and the stationary part with a second optical fiber element 4b. The second optical fiber element 4b leads to a spectrometer 8 in which the detected signals are processed. The connection of the IR light source 3 with the spectrometer 8 is carried out via electrical leads 9a, 9b. The electrical leads 9a, 9b are connected with each other in the first rotary feed through 7 via sliding contacts so that the IR light source 3 can be energized during operation. The rotary feed through 7 allows for the transmission of the optical or electrical signals between the spectrometer 8 and the measuring head 2, which is an interface between the sample and the spectrometer 8. In the embodiment shown in FIG. 1, the measuring head 2 is arranged coaxially to a suspension 10 around the axis of which the vessel 1 is rotated. Nevertheless, there are also different arrangements possible. Moreover, the rotation of the vessel can also be carried out by wobbling. The drive for the rotary motion is not shown in the figures.

FIG. 2 shows a version of the apparatus according to the invention in which the vessel 1 is fixed at two opposing suspensions 10a, 10b. In this way, the apparatus can withstand high loads, which is especially advantageous when using large mixing vessels.

The electrical lead 9b and the first optical fiber element 4a each run in one of the suspensions 10a, 10b of the vessel so that they are inducted into the vessel 1 at opposing sides. It is nevertheless also possible to implement the access for the electrical lead 9b and the first optical fiber element 4a not via the suspensions 10a, 10b but outside the rotary axis. It is also possible to introduce the electrical lead 9b and the first optical fiber element 4a together via an access to the interior of the vessel 1. While the connection of the first optical fiber element 4a with the second optical fiber element 4b is effected via a first rotary feed through 7a, a separate, second rotary feed through 7b is provided for the connection of the electrical lead 9b with the electrical lead 9a.

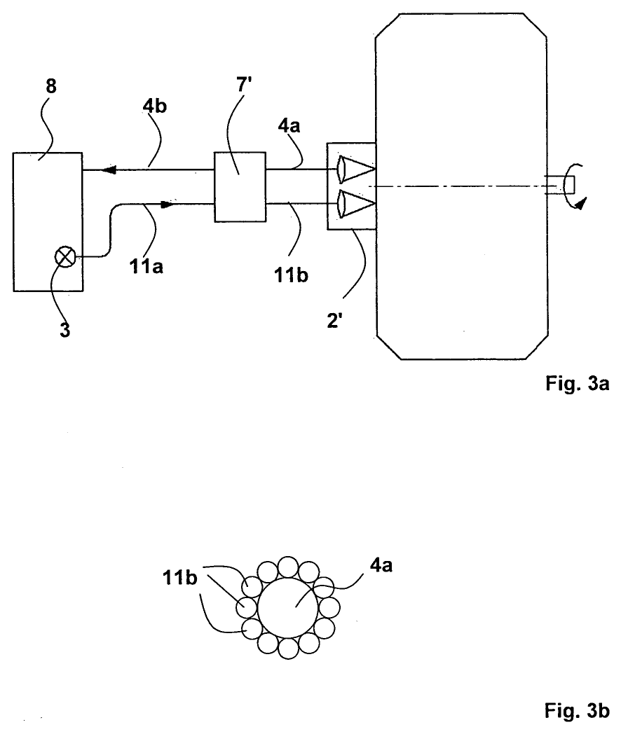

Apart from the spectrometer 8, the IR light source 3 can also be arranged externally in order to reduce the weight of the rotating parts. FIG. 3a shows such an arrangement. The IR radiation emanating from the IR light source 3 is transmitted to a measuring head 2′ via a third optical fiber element 11a and a fourth optical fiber element 11b, the coupling of the IR radiation being effected from the third optical fiber element 11a into the fourth optical fiber element 11b via a rotary feed through 7′. It is especially advantageous when the first and fourth optical fiber elements 4a, 11b as well as the second and third optical fiber element 4b, 11a are combined to one bundle each at least in the area of the rotary feed through 7′, as shown in FIG. 3b for the first and fourth optical fiber elements 4a, 11b. The first optical fiber element 4a consists of one single glass fiber and is surrounded by the fourth optical fiber element 11b in the form of a glass fiber ring. In this way, the coupling of the optical fiber elements 4a, 4b, 11a, 11b can be implemented via just one single rotary feed through 7′. The first optical fiber element 4a can also comprise a number of glass fibers surrounded by the glass fibers of the fourth optical fiber element 11b.

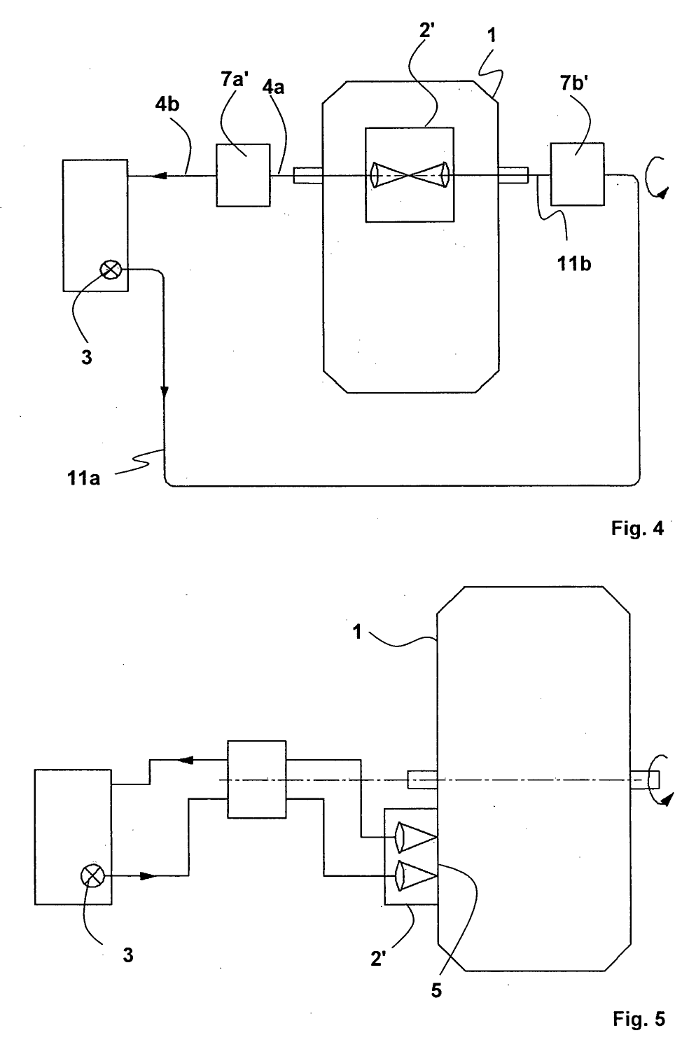

FIG. 4 shows another version of the analysis apparatus according to the invention with an external IR light source 3. Here, two separate rotary feed throughs 7a′, 7b′ are used for the couplings of the optical fiber elements 4a, 4b, 11a, 11b, for the transmission of the radiation.

FIG. 5 shows a version of the apparatus according to the invention with an external IR light source 3 in which the measuring head 2′ as well as the window 5 of the vessel 1 are arranged not along but eccentrically as to the rotary axis of the vessel 1.

The measuring head 2 can be arranged outside as well as inside the vessel 1 irrespective of the kind of suspension of the vessel 1.

### REFERENCE NUMERAL LIST

1 Vessel

2, 2′ Measuring head

3 IR light source

4a First optical fiber element

4b Second optical fiber element

5 Window

6 Optics

7, 7′, 7a, 7a′ First rotary feed through

7b, 7b′ Second rotary feed through

8 Spectrometer

9a, 9b Electrical leads

10, 10a, 10b Suspension

11a Third optical fiber element

11b Fourth optical fiber element ] http://www.pharmaceutical- hnology.com/contractors/lab-equip/carl-zeiss/carl_zeiss2. html Production Scale Blenders - Blending Systems; Pharmatech, tp://www.pharmatech.co.uk/pdf/ProductionBlenders.pdf

We claim:

1. An apparatus for the analysis of a sample by means of infrared (IR) spectroscopy, the apparatus comprising:
a vessel for holding the sample;
means for rotating said vessel;
a measuring head cooperating with said vessel;
a first rotary feed-through, said first feed-through having a rotating part and a stationary part;
at least one first optical fiber element for transmitting IR radiation reflected from the sample, said first fiber element being a single optical fiber or a bundle of several optical fibers, said first fiber element connected between said measuring head and said rotating part of said first rotary feed-through;
a stationary spectrometer; and
a second optical fiber element connected between said spectrometer and said stationary part of said first rotary feed-through, wherein the reflected IR radiation from the sample is passed from said first optical element to said second optical element and into said spectrometer.

2. The apparatus of claim 1, wherein said measuring head comprises at least one IR light source with which the sample is illuminated.

3. The apparatus of claim 2, further comprising sliding contacts at said first rotary feed through via which said IR light source is energized.

4. The apparatus of claim 2, wherein said IR light source is stationary.

5. The apparatus of claim 4, wherein said first and second optical fiber elements are each designed as individual optical fibers and said second optical fiber element comprises a beam splitter for coupling in IR light of the stationary IR light source.

6. The apparatus of claim 4, further comprising an illumination optics for illumination of the sample, said illumination optics having a third optical fiber element and a fourth optical fiber element, said third optical fiber element being connected to said IR light source and said fourth optical fiber element transmitting IR radiation from the IR light source to the sample.

7. The apparatus of claim 6, wherein said third optical fiber element is connected to said stationary part and said fourth optical fiber element is connected to said rotating part of said first rotary feed through, wherein either said first and second optical fiber elements or said third and fourth optical fiber elements are designed as ring-shaped optical fiber bundles in said first rotary feed through.

8. The apparatus of claim 6, wherein said vessel comprises two rotatable suspensions, said third optical fiber element being connected to a stationary part and said fourth optical fiber element to a rotating part of a second rotary feed through, said first rotary feed through being arranged at said first suspension and said second rotary feed through at said second suspension.

9. The apparatus of claim 1, wherein said vessel has a window and said measuring head is located at said window.

10. The apparatus of claim 9, wherein said measuring head is flanged at said window.

11. The apparatus of claim 9, wherein said window of said vessel is eccentric with respect to a rotary axis of said vessel.

12. The apparatus of claim 1, wherein said spectrometer is a Fourier spectrometer.
